(19) United States
(12) Patent Application Publication
(10) Pub. No.: US 2017/0245490 A1
(43) Pub. Date: Aug. 31, 2017

(54) PORTABLE TREE STAND SYSTEM

(71) Applicant: The System Tree Stands, LLC, St. James, NY (US)

(72) Inventors: Howard Habberstad, JR., St. James, NY (US); Mike Beatty, Xenia, OH (US)

(21) Appl. No.: 15/592,435

(22) Filed: May 11, 2017

Related U.S. Application Data
(62) Division of application No. 14/198,818, filed on Mar. 6, 2014, now abandoned.
(60) Provisional application No. 61/793,881, filed on Mar. 15, 2013.

(51) Int. Cl. A01M 31/02; F16M 13/02

(52) U.S. Cl. CPC A01M 31/02; F16M 13/02

(57) ABSTRACT

A portable platform for removable attachment to a vertically oriented base support includes a back portion and a base pivotably attached thereto. The back portion includes a coupling member configured for connection to a mounting member attachable to a vertically oriented base support. The base includes a brace extending therefrom. The base and back portion are movable between a folded configuration and an unfolded configuration such that the brace pressibly engages the vertically oriented base support when in the unfolded configuration.

### CROSS REFERENCE TO RELATED APPLICATIONS

This application is a divisional of U.S. patent application Ser. No. 14/198,818 filed on Mar. 6, 2014, which claims the benefit of and priority, under 35 U.S.C. §119, to U.S. Provisional Patent Application Ser. No. 61/793,881, filed on Mar. 15, 2013, the entire contents of which are incorporated by reference herein for all purposes.

### BACKGROUND

Technical Field

The present disclosure is directed to an apparatus for providing a vantage point at a vertical height along a vertically oriented support structure. More particularly, the present disclosure is directed to a system and method for removably mounting a portable support apparatus, such as a tree stand on a vertically oriented support structure, e.g., a tree.

Background of Related Art

Platforms such as tree stands are used for a variety of activities in which a stable platform for viewing from a vertical height is desired. For example, hunters and other outdoorsmen utilize platforms, commonly referred to as tree stands, to gain access to a vertical height along a vertically oriented support structure, such as a tree. From this position, a user can observe an area at the base of a tree and beyond, e.g., to hunt, survey an area, or observe wildlife movement patterns.

Many types of currently available platforms are permanently installed on a tree or other vertically oriented support structure. Such a configuration requires the installation of multiple platforms in order to provide multiple different observation points and may increase the need for the periodic, e.g., seasonal, replacement of the platform from constant use and/or exposure to natural elements, e.g., wind, rain, or local wildlife. Additionally, permanent installation of a platform may increase the chances of visual exposure of the location of the platform in situations where the platform is desired to be discreet, e.g., to avoid alerting passing wildlife or to keep a desirable hunting location a secret from other persons passing by.

Accordingly, it would be desirable to provide a portable platform and associated installation system that is configured such that the portable platform may be removably coupled with a vertically oriented support structure. Such a configuration would provide a user with a reusable portable platform that is versatile and ideal for placement in a variety of different locations. It would further be desirable to provide a compact, lightweight construction for the portable platform to facilitate ease of transport and mounting to a vertically oriented support structure.

### SUMMARY

In one aspect of the present disclosure, an embodiment of a portable platform for removable attachment to a vertically oriented base support is provided. The portable platform includes a back portion, and a base pivotably attached to the back portion. The back portion includes a coupling member configured for connection to a mounting member attachable to a vertically oriented base support. The base includes a brace extending therefrom. The base and back portion are movable between a folded configuration and an unfolded configuration such that the brace pressibly engages a vertically oriented base support when in the unfolded configuration.

In embodiments, the portable platform may further include at least one attachment surface extending from the back portion. The at least one attachment surface may be configured to receive a securing member. The portable platform may be configured to be secured to a vertically orientated base support with a securing member. The attachment surface may include a neck and a flange.

In embodiments, the base may further include a perimeter frame having a rearward portion connected to the back portion and a frontward portion. The brace may extend from the rearward portion of the perimeter frame. The brace may have a bent configuration and include a plurality of surface engaging features extending therefrom. The brace and the perimeter frame may be monolithically formed. The perimeter frame and the brace may be formed from extruded aluminum. It is contemplated that the brace may include a plate connected to the rearward portion of the perimeter frame.

In embodiments, the back portion may further include a seat. It is envisioned that the portable platform may further include a carrying hook disposed on the base. The carrying hook may be configured to support a weight of the portable platform. The carrying hook may be disposed at a center of gravity along a length of the portable platform in the folded configuration.

In embodiments, the portable platform may further include an accessory-holding extension arm apparatus disposed on the base. The accessory-holding extension arm apparatus may be configured to maintain an accessory in a substantially stationary position relative to the portable platform.

In another aspect of the present disclosure, an embodiment of a method of mounting a portable platform is provided. The method includes securing a mounting member to a vertically oriented support structure; inserting a coupling member of a portable platform into a cavity defined in the mounting member; securing the portable platform to the vertically oriented support structure with a securing member disposed about an attachment surface extending from the portable platform; and unfolding a base of the portable platform from a back portion of the portable platform such that a brace extending from a rearward portion of the base pressibly engages the vertically oriented support structure.

In embodiments, securing the mounting member to a vertically oriented support structure may include threadably inserting a portion of the mounting member into the vertically oriented support structure.

In embodiments, securing the mounting member to a vertically oriented support structure may include inserting a driving member through the cavity defined in the mounting member and rotating the driving member to cause rotation of the mounting member.

In some aspects of the present disclosure, securing the mounting member to a vertically oriented support structure may include inserting a driving member through an opening defined in the mounting member into engagement with a socket defined in the mounting member and rotating the driving member to cause rotation of the mounting member.

In some embodiments, securing the mounting member to a vertically oriented support structure may include rotating the driving member to cause rotation of the mounting member.

It is envisioned that securing the mounting member to a vertically oriented support structure may include overlying a driving member on a portion of the mounting member. The method may further include rotating a head defined on the driving member with a driving tool.

In embodiments, the method may further include securing the mounting member to the vertically oriented support structure with a securing strap.

In embodiments, the method may further include mounting a video recording device in relation to the portable platform.

In yet another aspect of the present disclosure, an embodiment of a portable support apparatus kit is provided. The portable support apparatus kit includes a portable platform and a mounting member. The portable platform includes a back portion including a coupling member and a base pivotably attached to the back portion. The base includes a brace extending therefrom. The mounting member includes a mounting portion and a threaded shank extending from the mounting portion. The mounting portion defines a cavity therein configured for disposal of the coupling member to couple the mounting member to the portable platform. The threaded shank portion extends from the mounting portion and is configured for penetrating fixation with a vertically oriented base support.

In embodiments, the portable support apparatus kit may further include a driving member configured for coupling with the mounting member and driving the mounting member into a vertically oriented base support.

In embodiments, the driving member may have a cross section configuration corresponding to the cavity of the mounting portion.

In some embodiments, the mounting portion may further include a proximal wall and a distal wall coupled thereto. The proximal wall may define an opening configured for disposal of a driving member. The opening may be in communication with the cavity. The threaded shank portion may extend from the distal wall of the mounting portion and be in coaxial alignment with the opening. The mounting portion may further include a pair of side surfaces interconnecting the proximal and distal walls. Each side surface of the pair of side surfaces may define a slit configured for passage of a securing member therethrough.

It is contemplated that the threaded shank portion may include a proximal portion and a distal portion. The proximal portion may include a flange having a tool engaging surface in communication with the cavity and configured for engaging a driving member. The tool engaging surface may include a hexagonal socket configured for coupling with a hexagonal portion of the driving member.

In embodiments, the portable support apparatus kit may further include a driving member configured to at least partially overlie the mounting portion and non-rotatably engage the mounting portion. The driving member may define a head configured for engagement with a driving tool.

In embodiments, the portable support apparatus kit may further include a carrying case designed and adapted for housing the portable platform. The carrying case may include a masking scent. The carrying case may be impermeable to odors.

In embodiments, the portable support apparatus kit may further include a shipping pouch designed and adapted for transporting the portable platform. The shipping pouch may include a masking scent.

In embodiments, the portable support apparatus kit may further include a securing member. The back portion may further include an attachment surface extending therefrom. The securing member may be configured to be disposed about the attachment surface to secure the back portion to a vertically oriented base support.

In embodiments, the portable support apparatus kit may further include a utility arm including a plurality of foldable arms.

In embodiments, the portable support apparatus kit may include a video recording device.

In embodiments, the portable support apparatus kit may further include at least one step.

### BRIEF DESCRIPTION OF THE DRAWINGS

Various aspects of the present disclosure are described herein with reference to the drawings wherein:

FIG. 1 is a perspective view of one illustrative embodiment of a portable platform according to the present disclosure;

FIG. 2 is a side view of the portable platform shown in FIG. 1 shown in the open configuration;

FIG. 3 is another side view of the portable platform of FIG. 1, which is shown in the closed configuration;

FIG. 4 is a plan view of an illustrative embodiment of a frame of the portable platform of FIG. 1;

FIG. 5 is a plan view of another illustrative embodiment of a frame of the portable platform of FIG. 1;

FIG. 6 is a front, perspective view of another illustrative embodiment of a portable platform according to the present disclosure;

FIG. 7 is a rear, perspective view of the portable platform of FIG. 6;

FIG. 8 is a perspective view of an illustrative embodiment of an installation system configured for interconnecting the portable platform and a vertically oriented base support;

FIG. 9 is a perspective view of one illustrative embodiment of a securing member for use with the installation system shown in FIG. 8;

FIG. 10 is a side view, in part phantom, of another illustrative embodiment of a mounting member of an installation system according to the present disclosure;

FIG. 11 is a perspective view, in part phantom, of the mounting member of FIG. 10;

FIG. 12 is a rear view of the mounting member of FIG. 10;

FIG. 13 is a perspective view of a hunter carrying the portable platform;

FIG. 14 is a perspective view of a support for use with the portable platform;

FIG. 15 is a side view of a plurality of the supports shown in FIG. 14, installed on a tree;

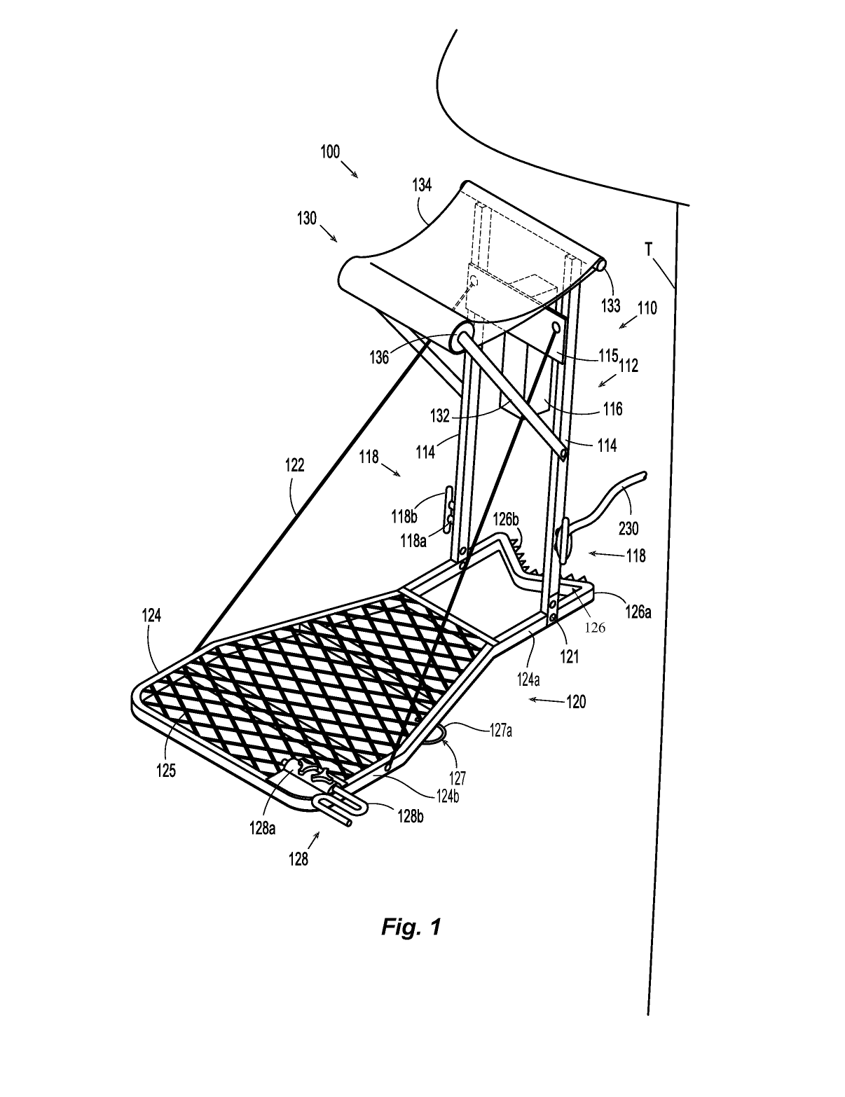

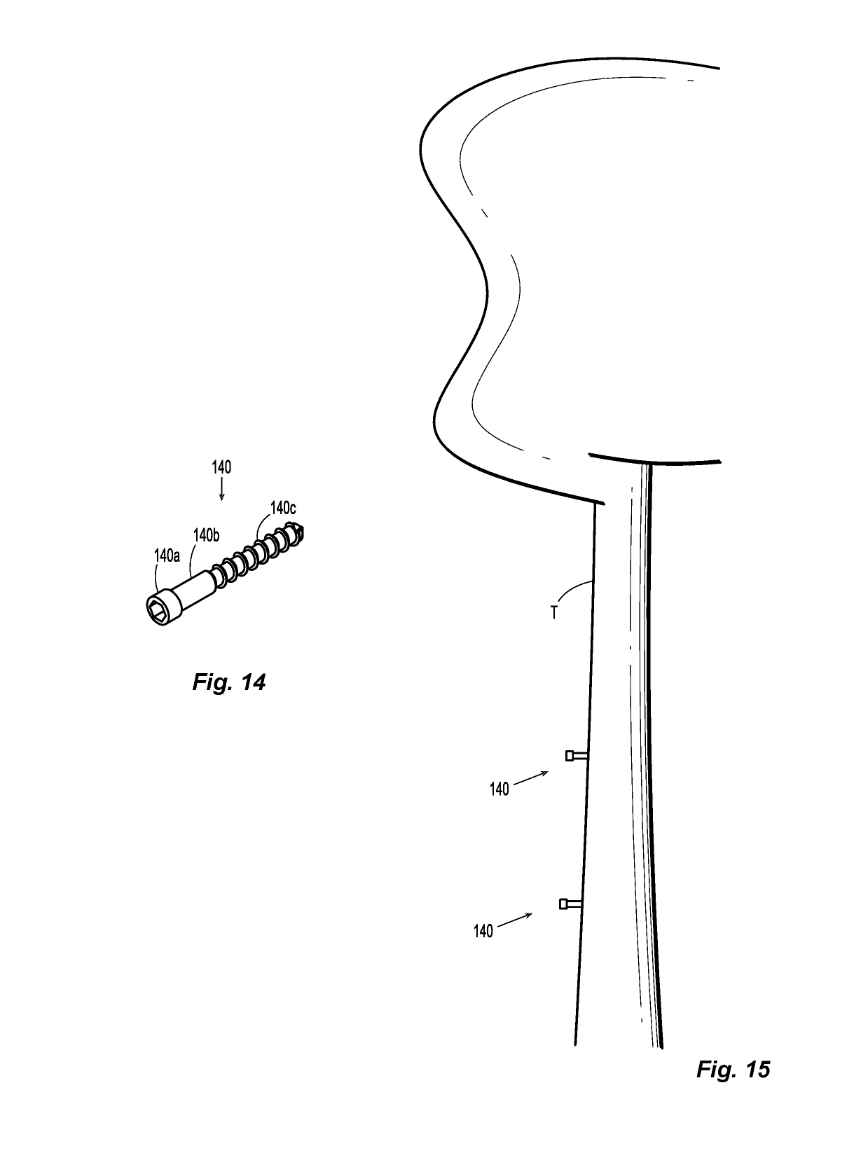

FIG. 14A is a perspective view of an alternative support for use with the portable platform of FIG. 1;

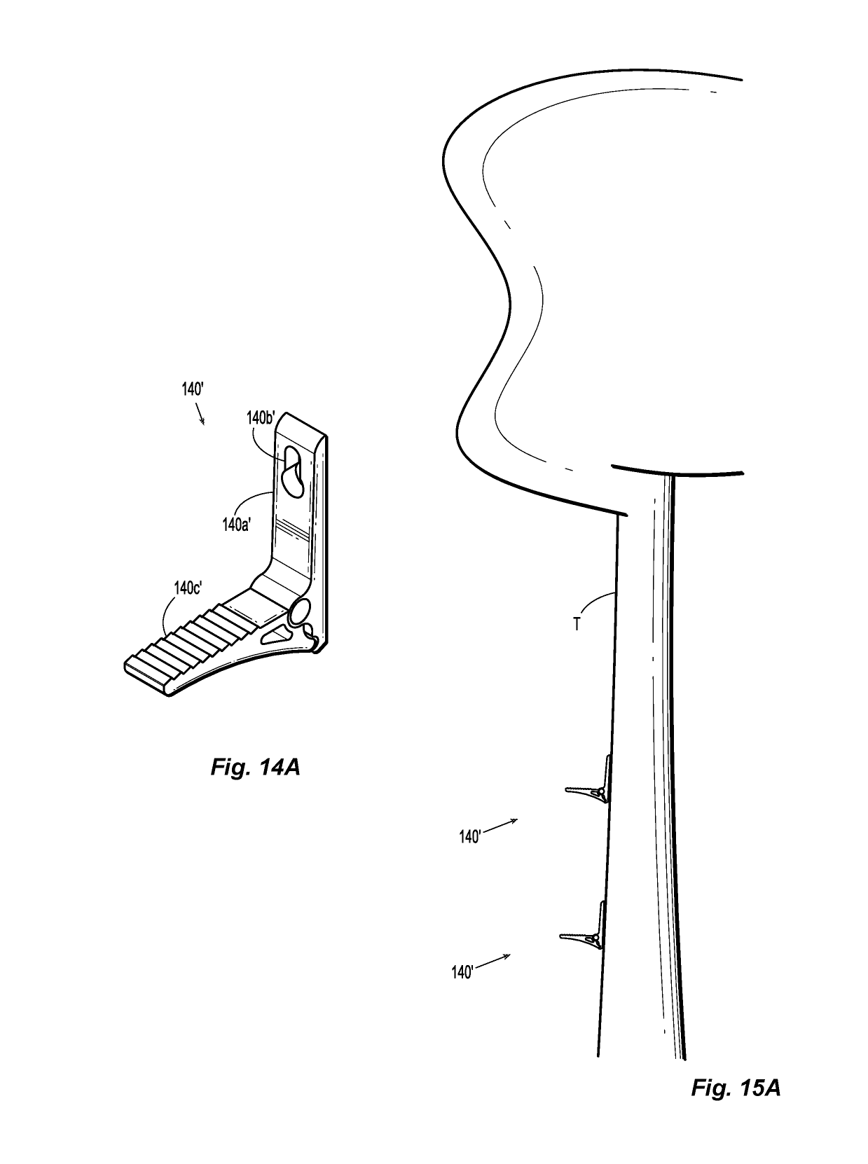

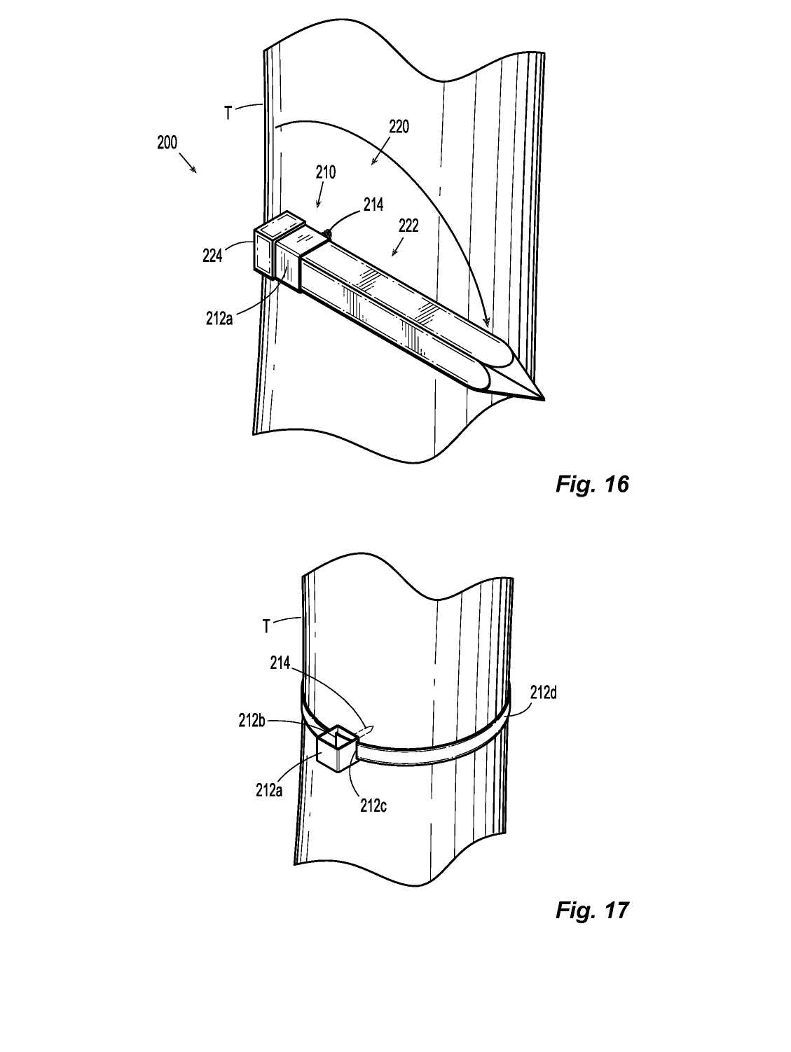

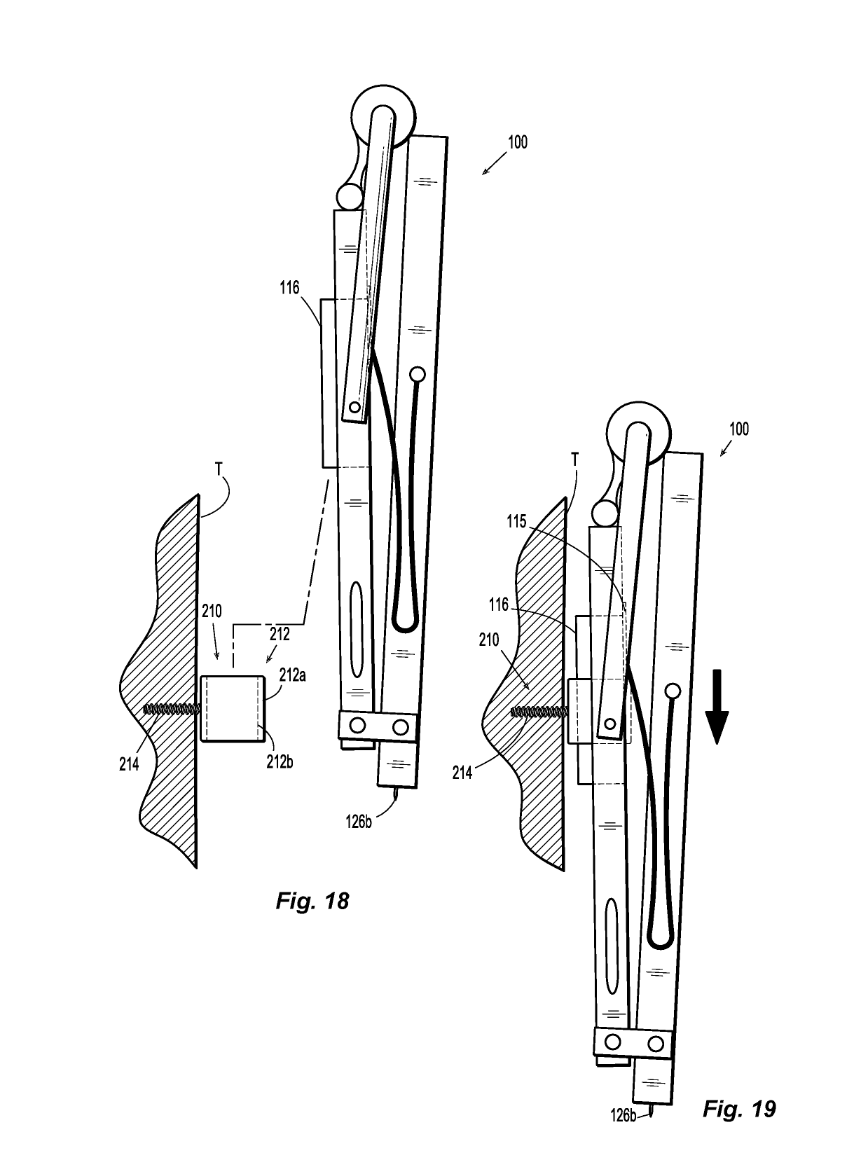

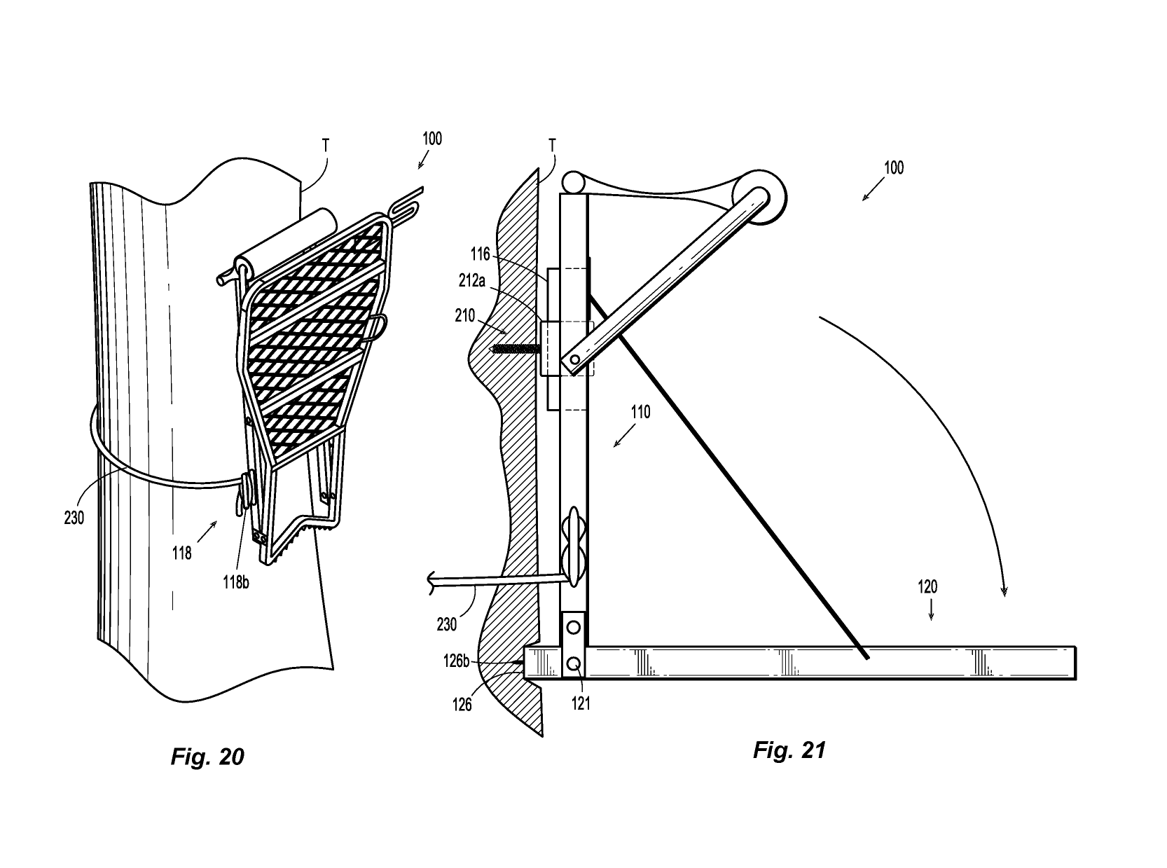

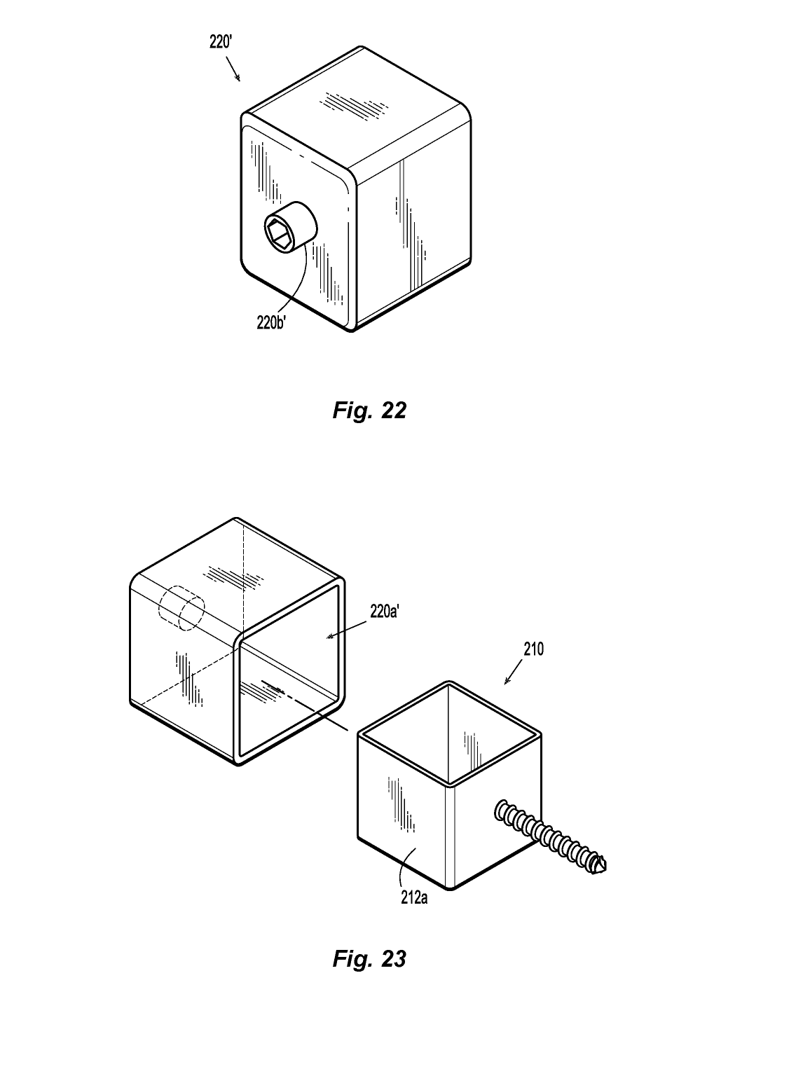

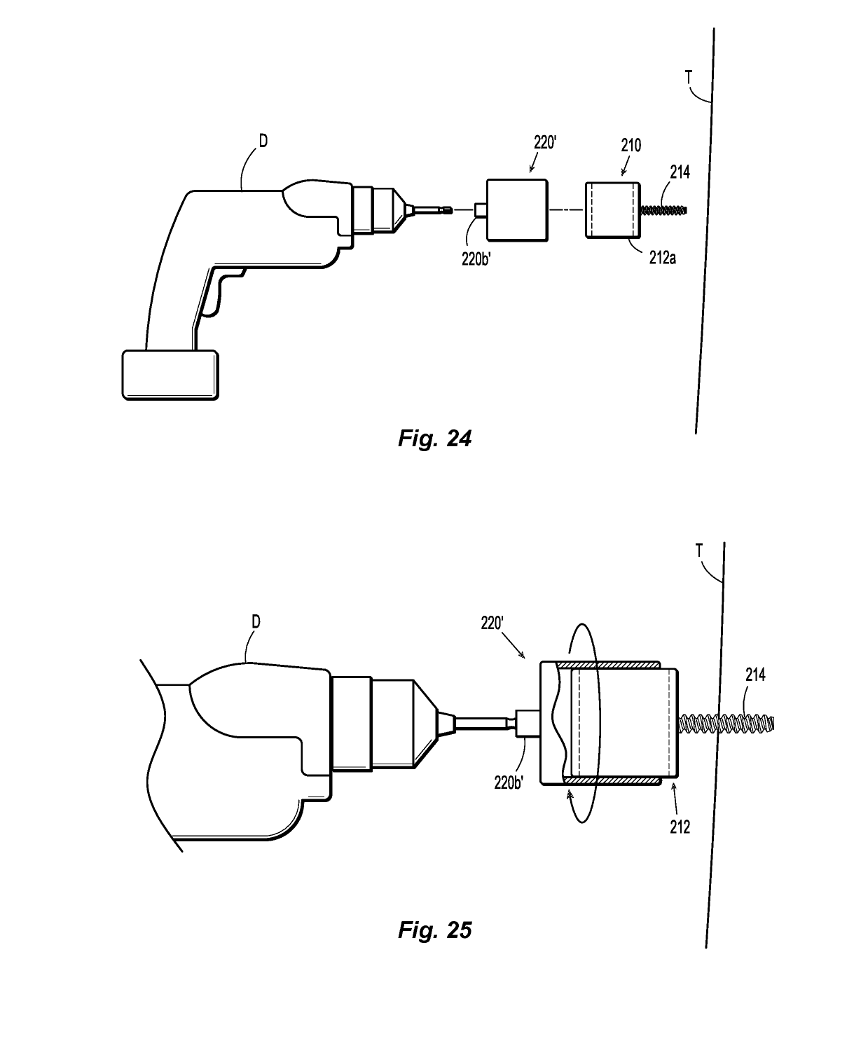

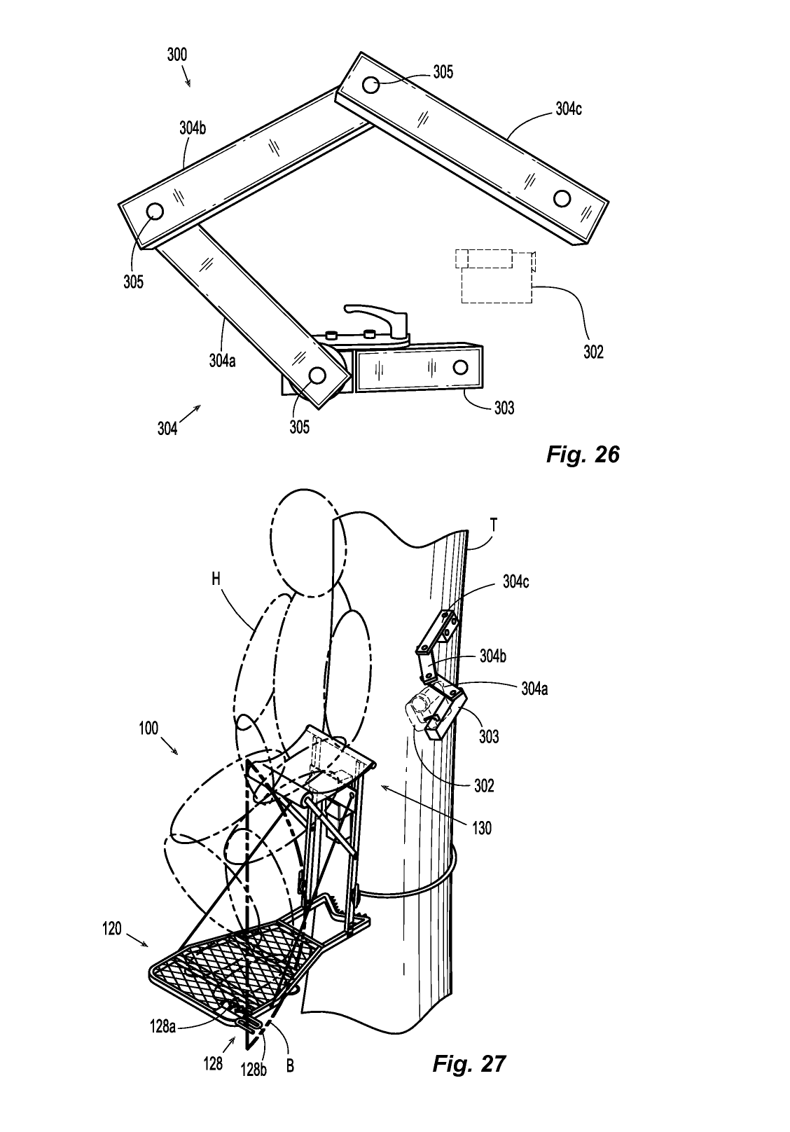

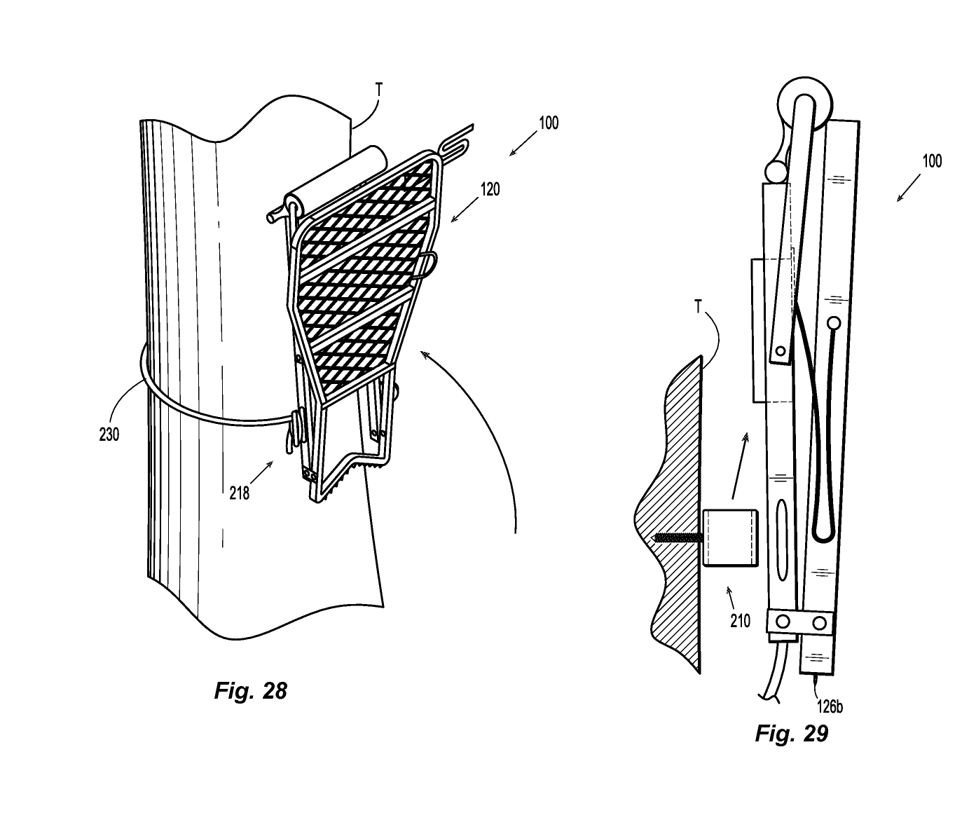

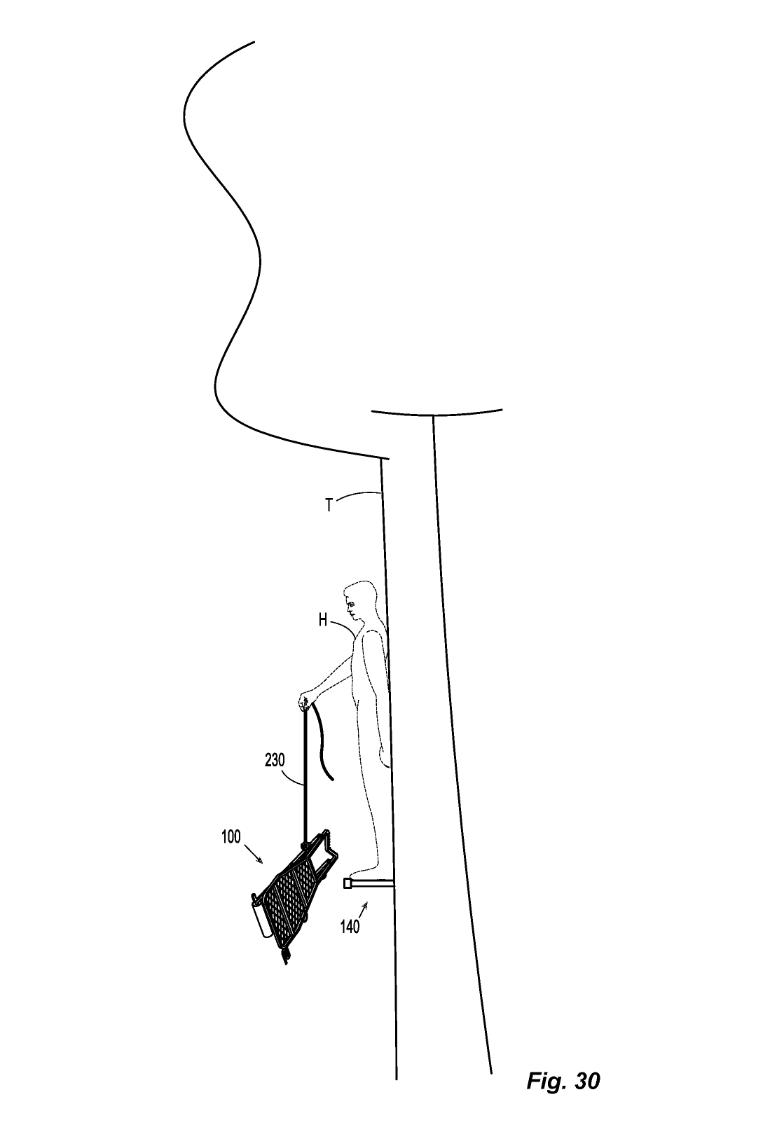

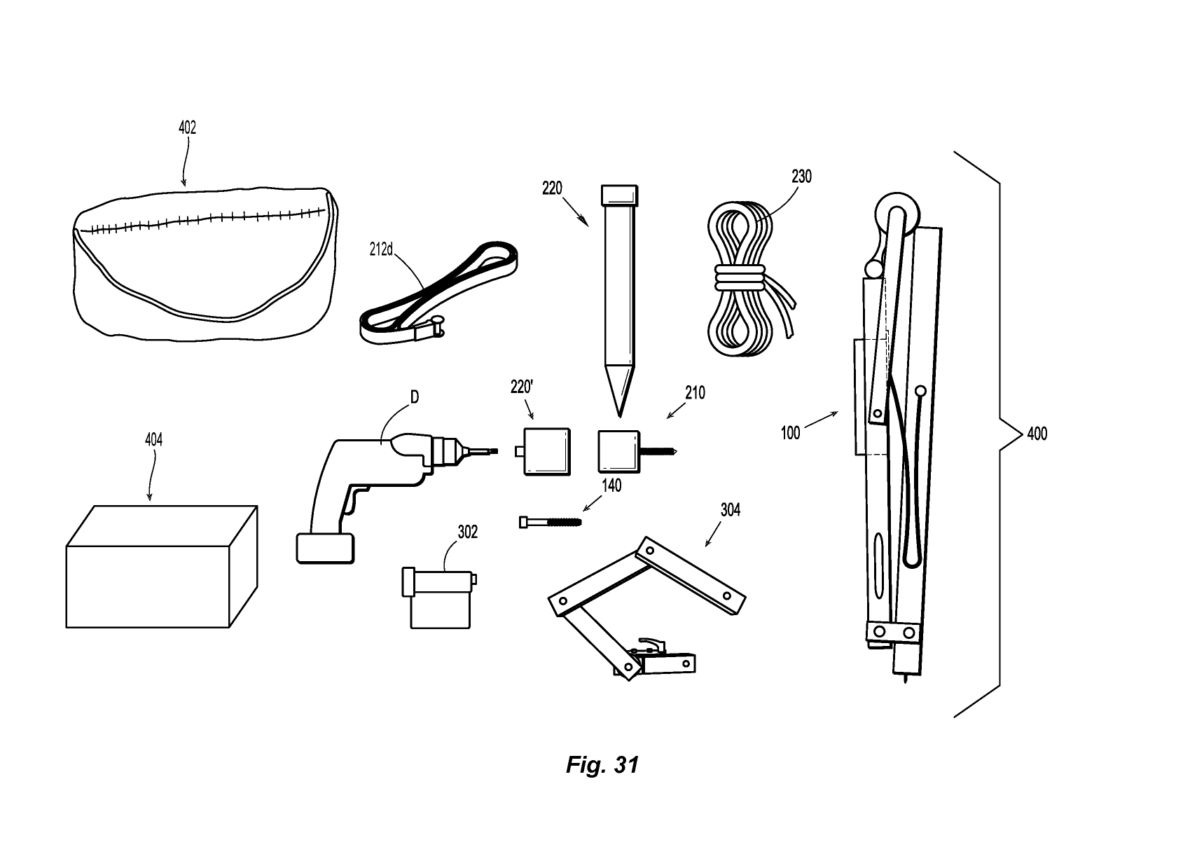

FIG. 15A is a side view of the support shown in FIG. 14A installed on a tree;

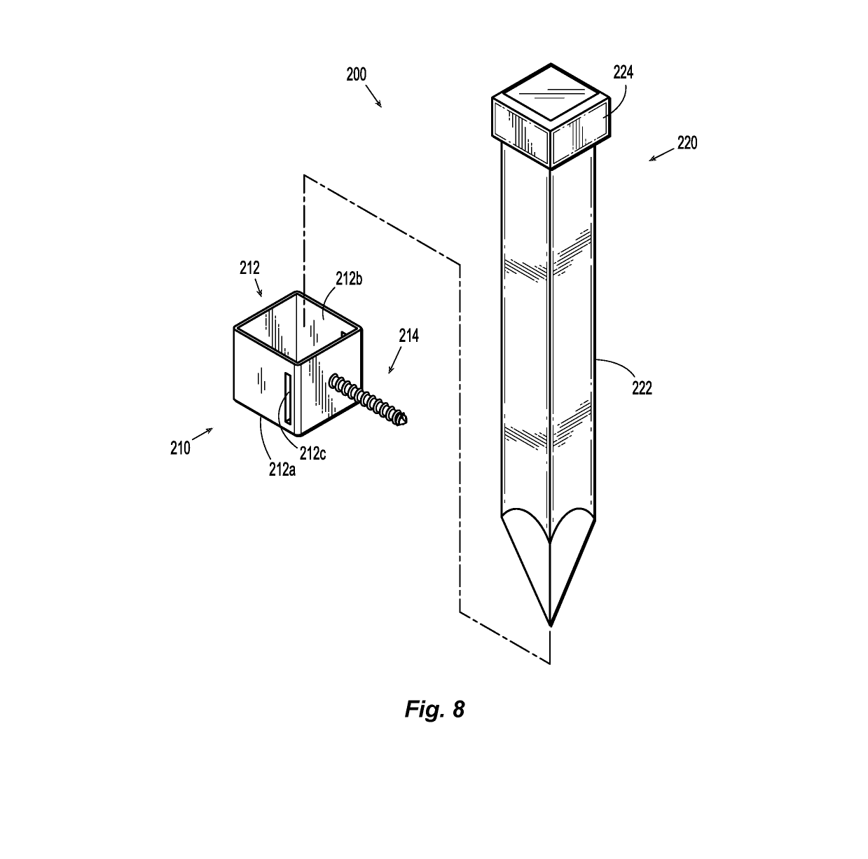

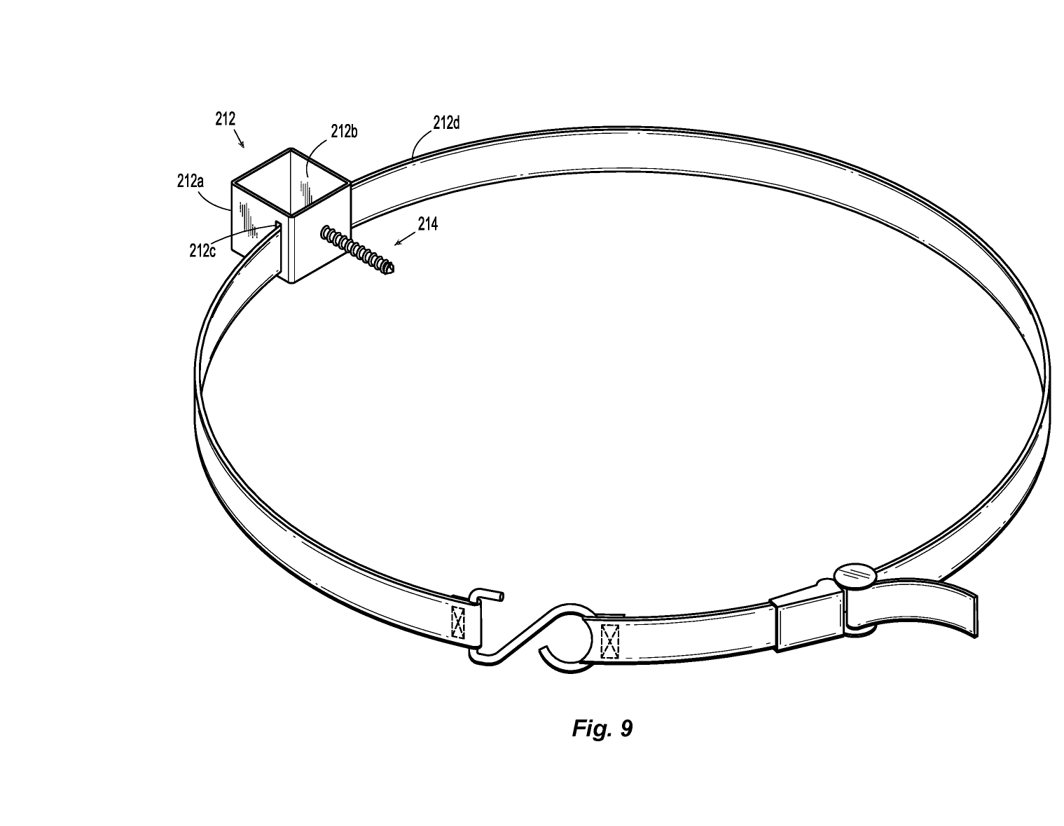

FIG. 16 is a perspective view of the mounting member of FIG. 8 being installed on a tree;

FIG. 17 is a perspective view of the securing member of FIG. 9 in use secured around the tree;

FIG. 18 is a first installation sequential side view of the portable platform of FIG. 1 in the folded configuration, prior to coupling with a tree;

FIG. 19 is a second installation sequential side view of the portable platform of FIG. 1 in the folded configuration, coupled with the tree;

FIG. 20 is a third installation sequential perspective view of the portable platform of FIG. 1 secured to the tree with a further embodiment of a securing member;

FIG. 21 is a fourth installation sequential side view of the portable platform of FIG. 1 coupled to the tree and being transitioned to the unfolded or open configuration;

FIG. 22 is a perspective view of an illustrative embodiment of a driving member according to the present disclosure;

FIG. 23 is a perspective view of the driving member shown in FIG. 22 being assembled with a mounting member;

FIG. 24 is a side view of the driving member and mounting member shown in FIG. 23, prior to installation on a tree with a driving tool;

FIG. 25 is a side view of the driving member and mounting member shown in FIG. 23 being installed on a tree with a driving tool;

FIG. 26 is a perspective view of an accessory-holding extension arm apparatus according to the present disclosure;

FIG. 27 is a perspective view of the accessory-holding extension arm apparatus shown in FIG. 26, installed on a tree in proximity to the portable platform of FIG. 1;

FIG. 28 is a first removal sequence side view of the portable platform of FIG. 1 being transitioned to the folded configuration prior to uncoupling with the tree;

FIG. 29 is a second removal sequence side view of the portable platform shown in FIG. 1 being uncoupled from the tree;

FIG. 30 is a third removal sequence side view of the portable platform of FIG. 1 being lowered from the tree with the securing member; and

FIG. 31 is a perspective view of an illustrative embodiment of a kit including the portable platform, installation system, accessory-holding extension arm, carrying case, and shipping pouch.

### DETAILED DESCRIPTION

Embodiments of the present disclosure are described hereinbelow with reference to the accompanying drawings. In the following description, well-known functions or constructions are not described in detail to avoid obscuring the present disclosure in unnecessary detail. Those skilled in the art will understand that the embodiments according to the present disclosure may be configured for use in a variety of locations and for any number of desired purposes.

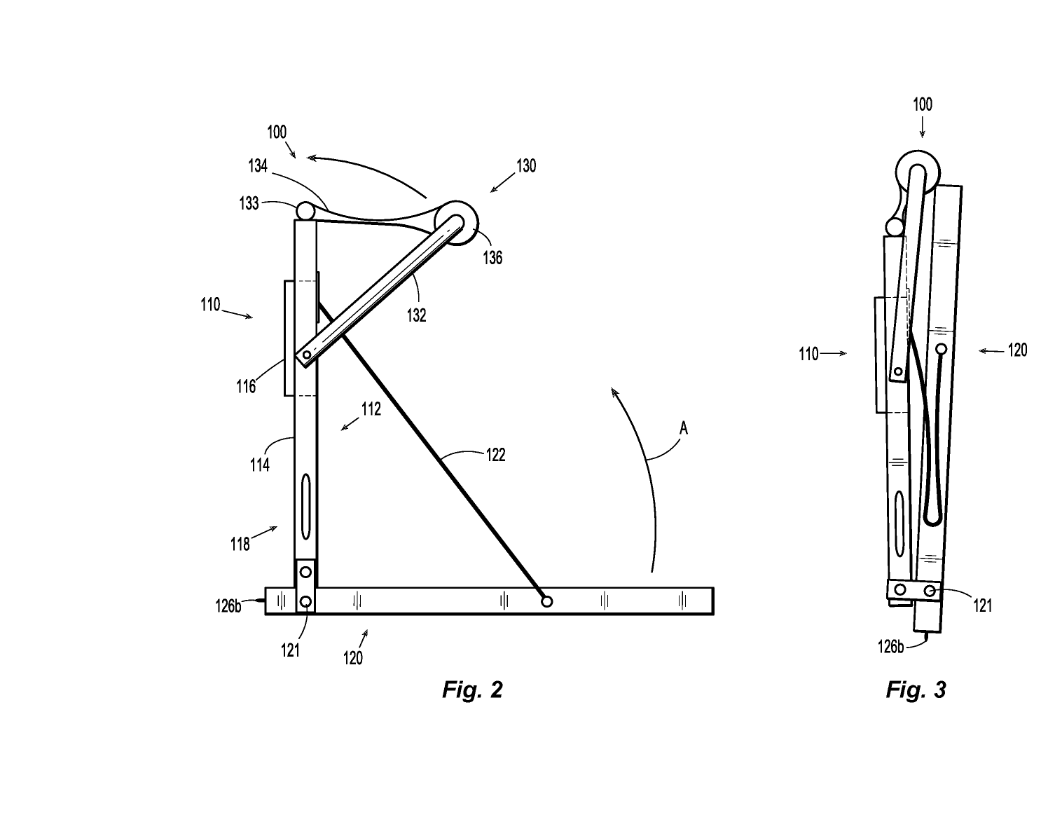

Referring initially to FIGS. 1 and 2, a portable support system includes a portable platform such as a tree stand 100 configured for removable attachment to a vertically orientated base support, such as a tree “T,” with an installation system 200 (FIG. 8), as will be described further below. It will be understood that tree stand 100 may be mounted to any suitable vertically oriented base support, e.g., a wall or other suitably stable structure. It will be further understood that any or all of the components of the tree stand 100 described herein may have any suitable configuration for their described purposes, and may be assembled and coupled in any desirable manner. Additionally, the components of tree stand 100 may be formed of suitable materials, e.g., metals or composites. In some embodiments, it is desirable to minimize the total weight of the tree stand 100 for ease of carrying and mounting. Accordingly, tree stand 100 may be partially or entirely formed of a lightweight material, e.g., a carbon fiber composite or lightweight alloy.

With additional reference to FIG. 3, tree stand 100 includes a back portion 110 and a base 120. The back portion 110 and the base 120 are pivotably attached via a hinge 121. Accordingly, back portion 110 and base 120 are configured to transition between a folded or closed configuration as shown in FIG. 3 and an unfolded or open configuration as shown in FIG. 2. In the unfolded configuration, the back portion 110 and base 120 extend in perpendicular relation away from the hinge 121. The base 120 may be approximated toward the back portion 110 as indicated by arrow “A” in FIG. 2 to define the folded or closed configuration in which the back portion 110 and base 120 together extend in parallel relation away from the hinge 121. Back portion 110 and base 120 may be pivotably attached by any suitable method as is known in the art, e.g., a pin connection or other hinge mechanism.

A pair of reinforcing support members such as cables 122 may extend between the back portion 110 and the base 120. Cables 122 may be rigid, e.g. arms or flexible members, such as cable, rope, or the like, that are configured to support some of the weight of the user and to inhibit hyper-extension of the base 120 relative to the back portion 110, as will be described further below. Cables 122 are configured to collapse, fold, or flex such that cables 122 do not interfere with transition of the tree stand 100 from the unfolded configuration to the folded configuration.

Still referring to FIGS. 1 and 2, the back portion 110 is defined by a frame 112. Frame 112, as shown in the illustrative embodiment, includes a pair of parallel bars 114 interconnected by a bridge member 115. Bridge member 115, as shown, may be configured as a plate having rigidity sufficient to maintain parallel bars 114 in their parallel and spaced orientation as the back portion 110 is subject to external forces during use. A coupling member such as a post or tube 116 is attached to a rear surface of the bridge member 115, and is disposed between and parallel to the parallel bars 114. Tube 116 extends downwardly along the frame 112 toward the hinge 121, and is configured for coupling with the installation system 200 (FIG. 8), as will be described further below. The components of frame 112 are coupled to define a rigid structure to withstand externally applied forces, e.g., equipment or a user's weight. Accordingly, parallel bars 114, bridge member 115, and coupling tube 116 may be interconnected in any manner as is known in the art, e.g., screws, rivets, welding, snap-fit, interference fit, or bayonet coupling.

As can be seen in FIG. 1, an attachment member such as a cleat 118 is attached to one or both of the parallel bars 114, as shown, and extends laterally away from the back portion 110. Cleat 118 includes a neck 118a attached to one of the parallel bars 114, and a flange 118b disposed on the neck 118a. The neck 118a defines an area that is exposed between the flange 118b and associated parallel bar 114 that is suitable for another member to be disposed or wrapped around, and the flange 118b maintains such a member in position about the neck 118a. Accordingly, the cleat 118 defines an attachment surface configured to receive a securing member 230, as will be described further below. It will be understood that alternative structures for receiving securing member 230, e.g., a flange, hook, or ring, may be employed on either or both of the parallel bars 114.

A seat 130 is coupled to the parallel bars 114 and may include an arm 132, a post 133 disposed atop the parallel bars 114, and a sitting surface such as seat fabric 134 disposed therebetween. Arm 132, as shown, has a substantially “U”-shaped configuration. The seat fabric 134 has ends supported on the arm 132 and the post 133 such that seat fabric 134 extends between the arm 132 and post 133 to define the sitting surface, as will be described further below. Seat fabric 134 may be wrapped around arm 132 and post 133 to define a double-layered seat, as shown, or seat fabric 134 may be otherwise secured to arm 132 and post 133. Arm 132 may include a foam covering 136 or other padded member disposed along all or a portion of its outer surface for seating comfort. Accordingly, foam covering 136 may have a tubular configuration.

Arm 132, as shown, may be pivotably attached to the parallel bars 114 of frame 112 such that seat 130 is configured to move between an unfolded configuration and a folded configuration. In the unfolded configuration, as shown, arm 132 is disposed in oblique relation to the parallel bars 114, and the seat fabric 134 extends between arm 132 and post 133 with a moderate amount of slack to define the seating area. Seat 130 is of a construction sufficient to withstand the applied force of, e.g., a seated person. In the folded configuration, the arm 132 is pivoted about its hinge and approximated toward the post 133 such that arm 132 is brought into engagement or near contact with the post 133. In this manner, seat 130 may be folded, e.g., for storage or transport.

With continued reference to FIGS. 1-3, as described above, base 120 is pivotably attached to the back portion 110 at the hinge 121, and includes a perimeter frame 124. Frame 124 has a rigid construction and may be formed of, e.g., a series of interconnected or bent bars. As shown, frame 124 may have a substantially “A”-shaped profile. Frame 124 may be formed of suitable lightweight materials such as aluminum, titanium, or composites. A grating 125 extends between the sides of frame 124, and provides a stable surface suitable to support the weight of, e.g., a person or object. Accordingly, grating 125 may be welded or otherwise fixedly secured to frame 124.

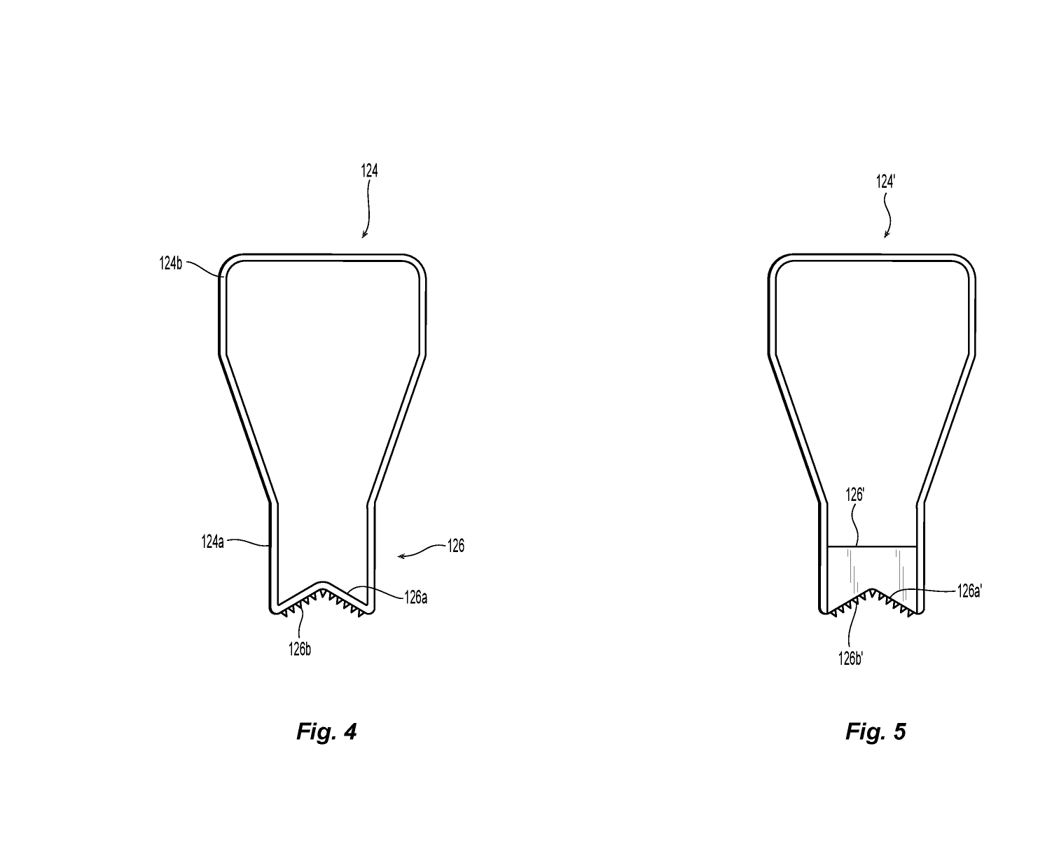

As best seen in FIGS. 1, 4 and 13, frame 124 has a rearward portion 124a and a frontward portion 124b. Back portion 110 is connected to rearward portion 124a of frame 124. Rearward portion 124a of frame 124 defines a brace 126 that extends from base 120. As shown in FIGS. 1 and 4, brace 126 and frame 124 are monolithically formed or integrally connected. Frame 124 and brace 126 can be fabricated from aluminum via an extrusion process such that frame 124 and brace 126 are one unitary piece. Brace 126 includes a bent body 126a that may have a substantially “M”-shaped or other symmetrical configuration, and includes a series of surface-engaging features 126b extending from the body 126a. Surface engaging features 126b may be configured as, e.g., teeth, ridges, or spikes. In this manner, brace 126 is configured for engaging tree “T,” as will be described further below.

In an alternative embodiment, as shown in FIG. 5, a frame 124′, similar to frame 124 discussed above, is connected to a brace 126′, which is in the form of a plate. Frame 124′ and brace 126′ can be connected via welding or some other suitable process for connecting metal materials. Brace 126′ includes a bent portion 126a′ having a series of surface-engaging features 126b′, similar to surface-engaging features 126b discussed above, extending therefrom. In some embodiments, frame 124′ and brace 126′ can be fabricated from various materials, such as, for example, any suitable materials disclosed herein.

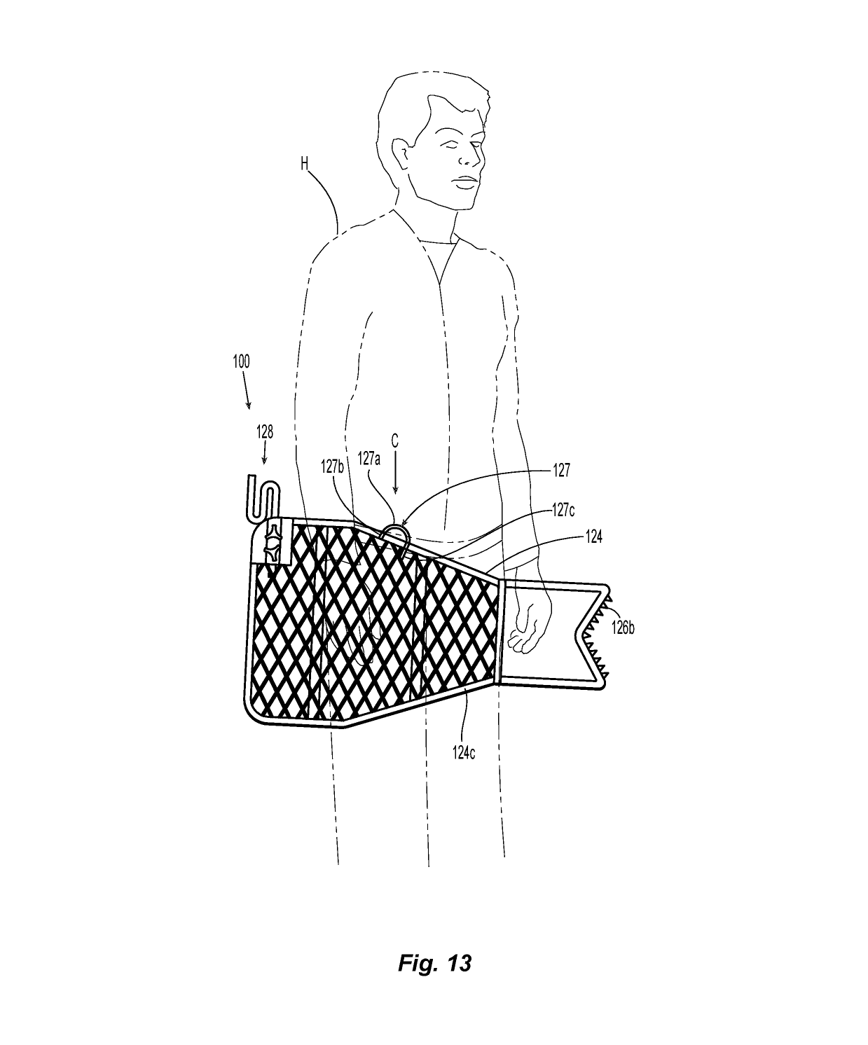

Turning back to FIGS. 1 and 13, a carrying hook 127 is attached to the frame 124 of the base 120, and may have a substantially “C”-shaped or ear-shaped configuration. In particular, carrying hook 127 has an outer curved portion 127a disposed outside of frame 124, a first arm 127b extending from curved portion 127a and a second arm or engagement end 127c also extending from curved portion 127a. First arm 127b is attached with a bottom surface 124c of frame 124 in a secure manner, e.g., through brazing or welding, or may be integrally formed with frame 124. Carrying hook 127 is fixedly attached to the frame 124 such that carrying hook 127 is sufficient to support the entire weight of the remainder of the tree stand 100.

Second arm or engagement end 127c of carrying hook 127 extends from outer curved portion 127a and toward an interior of frame 124. Engagement end 127c protrudes a distance inwardly from frame 124 and is spaced from bottom surface 124c of frame 124 such that engagement end 127c can be engaged with another structure for, e.g., carrying and transport. Engagement end 127c has an arcuate configuration configured to resist expulsion or dislodgement thereof from a surface to which it may be attached. For example, frame 124 can be coupled to a user's belt or belt loop by passing engagement end 127c of hook 127 through the belt loop or over the belt such that the belt or belt loop is secured in the space between engagement end 127c and bottom surface 124c of frame 124. In some embodiments, engagement end 127c may be variously configured, such as, for example, undulating, bent, textured, and/or variable.

An accessory-holding extension arm apparatus 128 is also attached to the frame 124 of the base 120, and includes a mounting portion 128a and an engagement portion 128b. Mounting portion 128a may be configured as a tubular clamping structure that is fixedly attached to the frame 124, e.g., by bolting, brazing or welding. Mounting portion 128a may be configured to receive the engagement portion 128b, e.g., via bolts, screws, or a clamping action. Engagement portion 128b has a substantially “S”-shaped configuration with curved portions configured for engagement with another member for the purposes of mounting additional equipment on the tree stand 100, as will be described further below. It is contemplated that engagement portion 128b may be removable from mounting portion 128a and replaced with e.g., a firearm holder or another accessory.

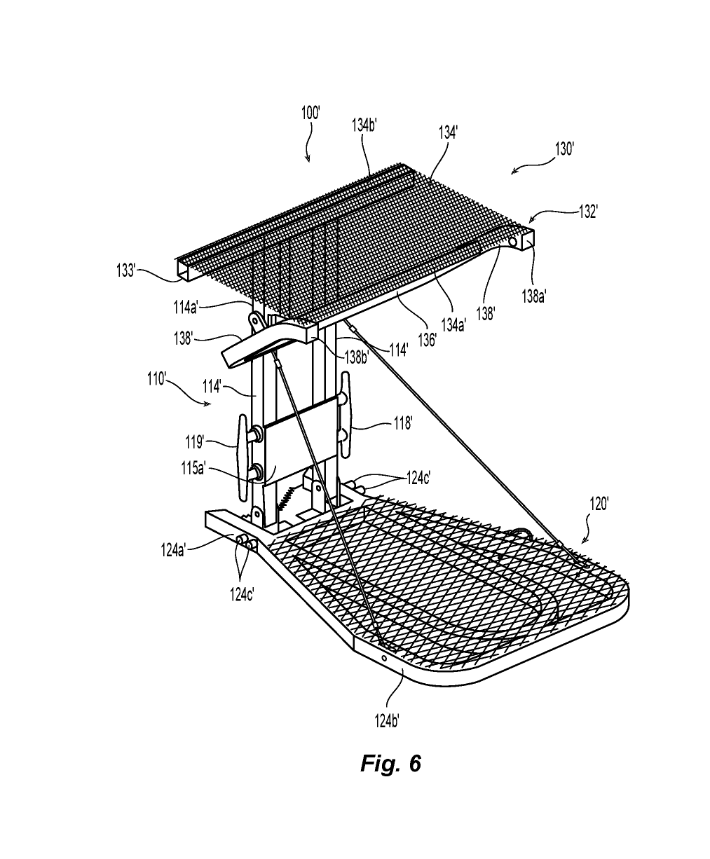

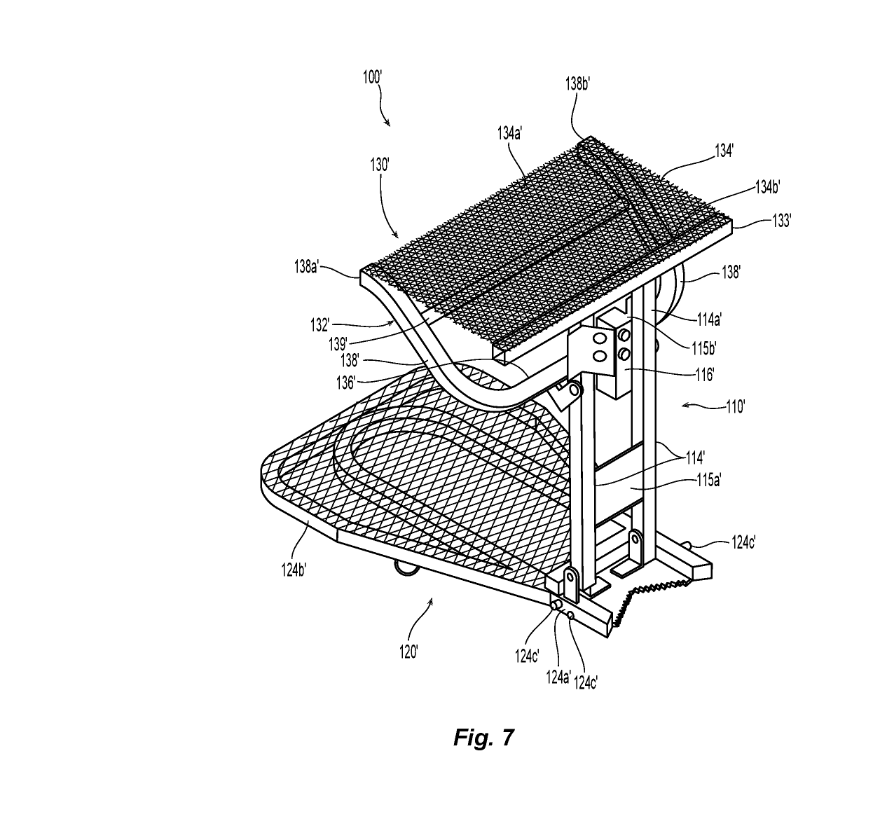

Turning briefly to FIGS. 6 and 7, an alternative, preferred embodiment of a portable platform or tree stand 100′, similar to tree stand 100 discussed above, is shown. Tree stand 100′ includes a base 120′, similar to base 120 discussed above, and a back portion 110′ pivotably connected to base 120′. Base 120′ has a rearward portion 124a′ and a frontward portion 124b′. Rearward portion 124a′ has two pairs of protrusions 124c′, for example, beads formed from welding, disposed on each side of base 120′.

Back portion 110′ includes a pair of parallel bars 114′ extending from rearward portion 124a′ of base 120′ and interconnected by a first bridge member 115a′ and a second bridge member 115b′. Back portion 110′ includes a pair of attachment surfaces, such as, for example, first and second cleats 118′, 119′, similar to cleats 118 described above. First cleat 118′ extends from a lateral surface of a first bar of parallel bars 114′ and second cleat 119′ extends from a lateral surface of a second bar of parallel bars 114′. Second bridge member 115b′ is spaced from first bridge member 115a′ along a length of back portion 110′ and interconnects a top portion 114a′ of parallel bars 114′. Second bridge member 115b′ has a trapezoidal configuration and includes a coupling member 116′, such as, for example, a post or tube attached thereto, similar to coupling member 116 discussed above. Coupling member 116′ is disposed in a plane intersecting bars 114′ and is oriented parallel to bars 114′. Coupling member 116′ is configured for disposal in a cavity 212b of a mounting member 210 to connect tree stand 100′ with mounting member 210, as further described below with reference to installation system 200.

Tree stand 100′ further includes a seat 130′, similar to seat 130 described above, coupled to parallel bars 114′. Seat 130′ may include a U-shaped member 132′, a post 133′ disposed atop the parallel bars 114′, and a sitting surface such as seat fabric 134′ disposed therebetween. U-shaped member 132′ is pivotably engaged to top portion 114a′ of parallel bars 114′ such that seat 130′ can be moved between a folded configuration (not shown) and an unfolded configuration, as shown. U-shaped member 132′ includes a base portion 136′ pivotably connected to parallel bars 114′, first and second legs 138′ each extending from base portion 136′, and a support bar 139′ interconnecting first and second legs 138′. Each leg 138′ has a curved distal end 138a′, 138b′. Seat fabric 134′ has a first end 134a′ supported on respective distal ends 138a′,138b′ of each leg 138′ of U-shaped member 132′ and a second end 134b′ connected to post 133′ such that seat fabric 134′ extends between U-shaped member 132′ and post 133′ to define the sitting surface. It is contemplated that U-shaped member 132′ can be variously shaped, such as, for example, V-shaped, undulating, uniform, non-uniform, variable, tapered, and/or squared.

In the folded configuration (not shown), distal ends 138a′, 138b′ of legs 138′ of U-shaped member 132′ are disposed upwardly in relation to post 133′. As seat 130′ is moved from the folded configuration to the unfolded configuration, as shown, legs 138′ of U-shaped member 132′ rotate away from parallel bars 114′ and toward frontward portion 124b′ of base 120′ until seat cover 134′ is fully extended and distal ends 138a′, 138b′ of legs 138′ are substantially coplanar with post 133′.

Turning now to FIGS. 8 and 9, the installation system 200 will be described. Installation system 200 includes a mounting member 210 and a driving member 220. Mounting member 210 and driving member 220 are configured for use with a tree “T” (FIG. 1), or with another suitable vertically-oriented support structure.

Mounting member 210 includes a mounting portion 212 and a shank portion 214. Mounting portion 212 includes a bracket 212a, and a cavity 212b defined therein. Cavity 212b may extend completely through mounting portion 212 to define a channel therethrough, or extend only partially therethrough such that cavity 212b defines a pocket in mounting portion 212. An aperture 212c may be defined in each lateral side of the bracket 212a for receiving a securing member, such as a strap 212d. Strap 212d is configured to be disposed around the tree “T,” as will be described further below.

Shank portion 214, as shown, extends away from the mounting portion 212, and is axially aligned and centered with the bracket 212a. Shank portion 214 may taper along its length and include an outer thread extending therealong. The outer thread of the shank portion 214 may have a self-tapping configuration, i.e., coarse, thread configuration. Mounting portion 212 and shank portion 214 are fixed to one another. Accordingly, mounting portion 212 and shank portion 214 may be integrally formed, or may be attached by, e.g., welding or brazing. In some embodiments, shank portion 214 may have a non-uniform diameter along its length, for example, shank portion 214 may have a proud center portion.

A driving member 220 is configured for insertion into the mounting member 210 through cavity 212b, and includes an insertion portion 222 and a flanged portion 224. Insertion portion 222 may be a substantially straight elongated member dimensioned to pass through the cavity 212b of the mounting portion 212 and sufficiently elongated so as to provide increased mechanical advantage for rotation of mounting member 210 during installation. Accordingly, a clearance is defined between the insertion portion 222 of the driving member 220 and the interior sides of the bracket 212a. Flanged portion 224 acts as a stop to inhibit the driving member 220 from passing completely through the cavity 212b. Insertion portion 222 and flanged portion 224 together define a length that may correspond to a dimension on the tree stand 100 (FIG. 1), as will be described further below. Driving member 220 may be pre-fabricated from, e.g., wood, metal, or composite. Additionally, driving member 220 may include an outer coating, e.g., a sprayable material or fabric tape, that serves to provide sound-dampening qualities during use, to camouflage driving member 220, and/or to maintain the surface integrity of driving member 220, e.g., to minimize splintering or surface scratching. In some embodiments, a driving member for use with mounting member 210 may be improvised from available materials, e.g., a stick, log, or other substantially straight, elongate member.

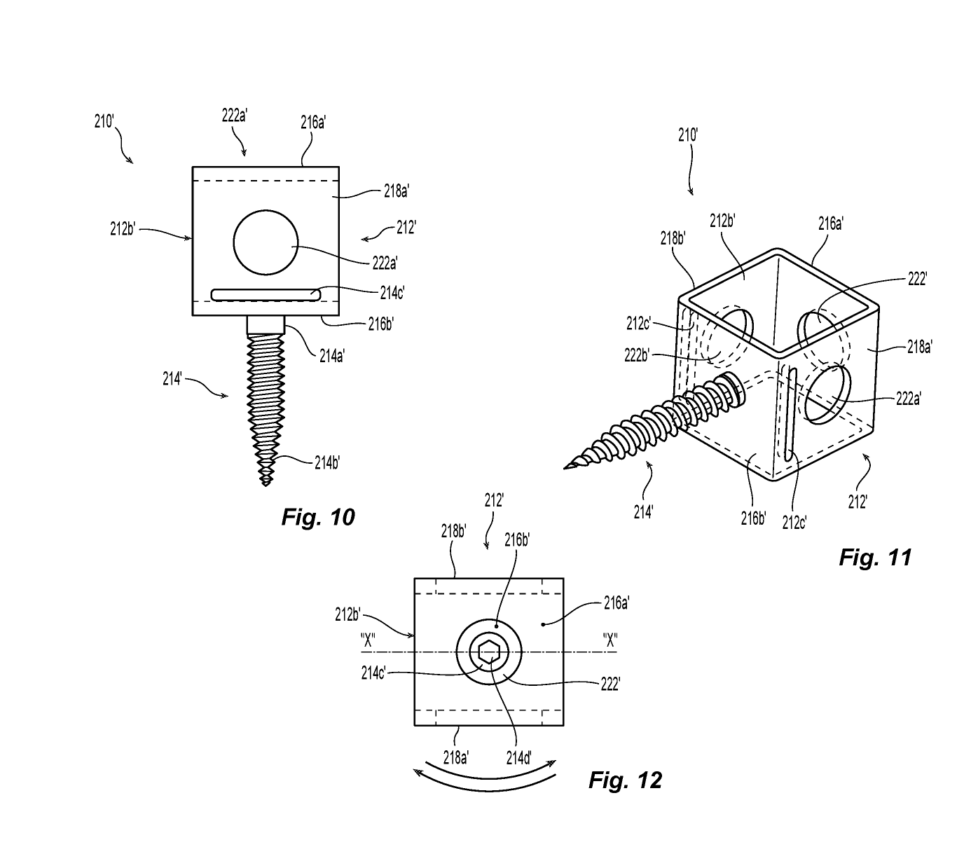

Turning momentarily to FIGS. 10-12, an alternative embodiment of a mounting member, designated as 210′, of installation system 200 is shown. Mounting member 210′ includes a mounting portion 212′ and a shank portion 214′. Mounting portion 212′ defines a cavity 212b′ therein. Cavity 212b′ may extend completely through mounting portion 212′ to define a channel that extends along an axis that is substantially perpendicular to shank portion 214′. In one embodiment, cavity 212b′ may extend only partially through mounting portion 212′ such that cavity 212b′ defines a pocket in mounting portion 212′. Cavity 212b′ is configured for disposal of coupling member 116 of tree stand 100 to couple mounting member 210′ to tree stand 100.

Mounting portion 212′ includes a proximal wall 216a′, a distal wall 216b′ and a pair of lateral side surfaces 218a′, 218b′ interconnecting proximal and distal walls 216a′, 216b′. Mounting portion 212′ may have a substantially squared configuration. Proximal wall 216a′ defines an opening 222′ configured for disposal of a driving member, such as, for example, driving tool “D” (FIG. 31). Opening 222′ is in communication with cavity 212b′ such that driving tool “D” can be inserted through opening 222′, into cavity 212b′, and into engagement with distal wall 216b′. An aperture or slit 212c′ may be defined in each lateral side 218a′, 218b′ of mounting portion 212′ for receiving a securing member, such as strap 212d discussed above.

In some embodiments, each lateral side 218a′, 218b′ may further include an opening 222a′, 222b′ defined therein in communication with cavity 212b′. Openings 222a′, 222b′ provide an alternative pathway for a driving member, such as, for example, driving tool “D”, to engage a socket 214d′ of mounting member 210′ for driving or rotating mounting member 210′ into a tree “T.” It is also contemplated that openings 222a′, 222b′ provide a pathway for a driving member to be inserted therebetween such that a rotation of the driving member causes mounting member 210′ to rotate.

Shank portion 214′, as shown, extends away from distal wall 216b′ of mounting portion 212′, and is axially aligned and centered with opening 222′ of mounting portion 212′ and substantially perpendicular to an axis “X” extending through cavity 212b′. Shank portion 214′ may taper along its length and include an outer thread extending therealong. The outer thread of the shank portion 214′ may have a self-tapping configuration, i.e., coarse, thread configuration. Shank portion 214′ has a proximal portion 214a′ fixed to distal wall 216b′ of mounting portion 212′ and a distal portion 214b′. Proximal portion 214a′ includes a flange 214c′ disposed in cavity 212b′. Flange 214c′ defines a tool engaging surface, such as, for example, a hexagonal socket 214d′, configured for coupling with a hexagonal portion of driving tool “D.” In this way, driving tool “D” can be inserted through opening 222′, and into engagement with socket 214d′, to drive or rotate, as shown, threaded shank portion 214′ into a vertically oriented base support, such as a tree “T.” It is contemplated that socket 214d′ can be variously shaped, such as, for example, as any non-circular surface configured for relative non-rotatable engagement with a correspondingly shaped driving tool of driving tool “D.”

Turning now to FIGS. 13-21, a method of installation and use of the tree stand 100 will be described. The following method of installation and use of tree stand 100 can also be used to install and use tree stand 100′. In FIG. 13, the tree stand 100 is shown in the folded configuration, and being carried by a user, such as a hunter “H.” Hunter “H” may be any person desiring a platform along a vertically oriented support structure, e.g., an outdoor sportsman. Tree stand 100, as shown, has a varied weight distribution across its length that is determined by the different-weighted components of tree stand 100 described above. However, carrying hook 127 is disposed at a center of gravity “C” along a portion of tree stand 100, i.e., carrying hook 127 is disposed substantially at the lengthwise center of gravity of tree stand 100 in the folded configuration to facilitate balancing the tree stand 100 when suspended by the carrying hook 127. Accordingly, the tree stand 100 may be attached, via carrying hook 127, to a point on hunter “H,” e.g., a belt, waistband, webbing, or harness, and the net moment forces about the carrying hook 127 will be substantially zero, i.e., the tree stand 100 will be balanced about the point of attachment to the hunter “H.” Additionally, the tree stand 100 may be balanced against a weighted object disposed on an opposite side of the hunter “H,” e.g., a tool, hunting bow, or counterweight. In this manner, the tree stand 100 may be carried in a substantially hands-free fashion such that the hunter H is free, e.g., to perform other tasks or to reduce fatigue.

Turning to FIGS. 14 and 15, in order to access a suitable mounting position at a vertical height along tree “T,” one or more supports such as steps 140 may be utilized. Steps 140 may have an elongate configuration including a head portion 140a, an unthreaded shank portion 140b, and a threaded shank portion 140c. Threaded shank portion 140c may have an outer thread configured as a self-tapping, i.e., coarse, thread configuration. Head portion 140a may have a configuration suitable for use with a driving tool, e.g., a hex head, as will be described further below.

Referring to FIGS. 14A and 15A, an alternative embodiment of a step, designated as step 140′, may be in the form of a detachable folding configuration, and have a mounting portion 140a′ defining an aperture 140b′, and a support portion 140c′. Mounting portion 140a′ and support portion 140c′ may be pivotably or pivotally attached and have a substantially perpendicular arrangement in the open configuration, as shown in FIG. 14A. Mounting portion 140a′ may be secured to a tree “T” by any suitable means, e.g., a fastener such as a peg inserted into the trunk of tree “T” such that step 140′ may be hung thereon through aperture 140b′. Accordingly, steps 140′ are configured such that the mounting portion 140a′ may be secured to the tree “T,” and the support portion 140c extends in a substantially perpendicular fashion away from the tree “T” to define a generally horizontally oriented surface on which a hunter “H” may stand, e.g., to climb tree “T.” Accordingly, support portion 140c may define a frictional surface, e.g., grooves, sand embedded paint, or the like suitable for gripping the footwear of hunter “H” so as to provide a non-slip surface. In this manner, the steps 140′ are configured to support the weight of hunter “H.” In some embodiments, steps 140′ may incorporate a locking mechanism, e.g., a key lock, to store the steps 140′ in a folded configuration, e.g., to minimize theft between periods of use. In some embodiments, other structures may be used to gain access to higher portions of a tree “T,” e.g., a ladder or climbing rope.

Turning now to FIGS. 16 and 17, preparation of the tree “T” with the installation system 200 and mounting of the tree stand 100 will be described in detail. The mounting member 210 is aligned with the tree “T,” i.e., oriented such that the shank portion 214 intersects a surface of the tree “T” at a substantially perpendicular angle. The driving member 220 may be used to strike, i.e., hammer, the mounting portion 212 of the mounting member 210 such that a pilot hole or entry mark is created on the tree “T” by the subsequent impact of the shank portion 214 with the tree “T.” Thereafter, the insertion portion 222 of the driving member 220 is inserted through the channel 212b of the bracket 212a of the mounting member 212, and advanced through the channel 212b until or upon engagement of the flanged portion 224 of the driving member 220 with the bracket 212a of the mounting member 210. Alternatively, the mounting member 212 may be positioned on driving member 220 first and the mounting member 212 may be swung by the driving member 220 such that the tip of shank portion 214 impacts the tree at a chosen location so as to drive the tip into the tree deep enough to set the location of the mounting member 210.

The driving member 220 is then rotated as shown in FIG. 16 such that the mounting member 210 is caused to rotate about an axis defined by the shank portion 214, and the shank portion 214 threadably engages the tree “T.” Continued rotation of the driving member 220 results in the shank portion 214 being threadably advanced to a position partially or completely disposed within the tree “T” (shown in phantom in FIG. 17), with the bracket 212a of the mounting member 210 exposed on an outer surface of the tree “T.” It is desirable to ensure that the channel 212b of the bracket 212a is placed in a substantially vertical orientation with respect to the tree “T”. The user can confirm the desired vertical orientation by observing the orientation of driving member 220 to confirm that it is vertically oriented. Additionally, driving member 220 may include a level bubble therein (not shown). Thereafter, the driving member 220 may be removed from the channel 212b of the bracket 212a. In this manner, mounting member 210 is secured to the tree “T” in the desired orientation.

Strap 212d or another securing member may be inserted through the apertures 212c in the bracket 212a to further secure the mounting member 210 to the tree “T”. Strap 212d may be extended around the circumference of the tree “T” and secured in the apertures 212c by, e.g., a clamp or clasp to further secure mounting member 210 to tree “T”.

Turning now to FIGS. 18 and 19, with the bracket 212a of the mounting member 210 exposed outside the tree “T”, the tree stand 100 may be coupled with the mounting member 210. As shown, the tree stand 100 is coupled to the tree “T” in the folded configuration. As described above, the tube 116 is exposed along the back portion 110 of the tree stand 100, and is dimensioned for insertion into the cavity 212b of the bracket 212a of the mounting member 210. The tube 116 is inserted through the cavity 212b of the bracket 212a, and the bridge member 115 may act as a stop to inhibit over-insertion of the tube 116. With the shank portion 214 of the mounting member 200 securely disposed in the tree “T”, and the strap 212d (FIG. 17) providing an additional measure of secure coupling, the mounting member 210 supports the weight of the tree stand 100 on the tree “T”. Accordingly, the hunter “H” (FIG. 13) is free to release the tree stand 100 and use both hands to secure tree stand 100 to the tree “T” with the securing member 230.

Referring additionally to FIG. 20, the securing member 230 is shown further securing the tree stand 100 to the tree “T”. Specifically, securing member 230 extends around the outer circumference of tree “T”, and attaches to tree stand 100. Securing member 230 may be, e.g., a rope, strap, belt, or any suitable longitudinal member that resists flexing under a tensile force. Securing member 230 is disposed about a cleat 118, and extends around tree “T” to engage the cleat 118 on the opposite side of the back portion 110. In this manner, cleat 118 serves as an engagement surface about which securing member 230 may be, e.g., tied, lashed, wound, knotted, or otherwise wrapped. Specifically, the neck 118a (best shown in FIG. 1) of the cleat 118 is configured to receive securing member 230, and the flange 118b is configured to retain the securing member 230 thereon. The securing member 230 reinforces the coupling of the tree stand 100 and the tree “T”, and substantially removes any freedom of movement afforded the tree stand 100 owing to clearance between the tube 116 and the interior sides of the bracket 212a of the mounting member 210. In this manner, the tree stand 100 is configured to be secured to the tree “T” or another vertically oriented base support with the securing member 230.

Turning to FIG. 21, once the tree stand 100 is coupled to the tree “T” with the mounting member 210, and further secured to the tree “T” with the securing member 230, the tree stand 100 may be transitioned from the folded configuration to the unfolded configuration, as shown. The hunter “H” grasps the base 120 and pivots the base 120 about the hinge 121 to transition the tree stand 100 to the unfolded configuration.

As the base 120 pivots downwardly into the unfolded configuration, the brace 126 extending from the base 120 pressibly engages the tree “T.” The tree stand 100 is dimensioned such that, when the tree stand 100 is coupled to the tree “T” with the mounting member 210, and secured to the tree “T” with the securing member 230, and the tree stand 100 is transitioned to the unfolded configuration, the brace 126 extends rearward past the back portion 110 to pressibly engage the tree “T.” As the brace 126 engages the tree “T,” a camming action of the base 120 causes the bottom portion of the back portion 110 to pivot or tilt outwardly with respect to the tree “T” and provide added tension to securing member 230, i.e., the wound securing member 230 is pulled taught by the camming action of the brace 126 and back portion 110 against the tree “T.” In this manner, brace 126 provides an added measure of secure coupling between the tree stand 100 and the tree “T.” Accordingly, the surface engaging features 126b of brace 126 may dig or delve into the tree “T” to inhibit the movement of tree stand 100 relative to tree “T.” Additionally, the symmetrical configuration of the body 126a of brace 126 may inhibit lateral rocking of the tree stand 100 on the tree “T.”

As described above, the driving member 220 (FIG. 8) may be dimensioned to correspond to a point on the tree stand 100 in the unfolded configuration. Specifically, a bottom end of the insertion portion 222 of the driving member 220 may indicate the position of the base 120 of the tree stand 100 as it extends perpendicularly away from the tree “T” in the unfolded configuration. In this manner, the driving member 220 may be used to approximate the vertical height of the base 120 on the tree “T” prior to coupling the tree stand 100 with the mounting member 210. This alignment feature will permit the user to reliably predict the exact lateral and vertical position of the base 120 of tree stand 100 and more specifically, whether the location is suitable for a secure engagement of brace 126 with the tree “T.”

Turning momentarily to FIGS. 22-25, an alternative embodiment of a driving member, designated 220′, is shown. Driving member 220′ is configured for use with mounting member 210 described above. Driving member 220′, as shown, is configured as a block defining a recess 220a′ therein, i.e., a socket. Recess 220a′ has a larger dimension and complementary configuration to the bracket 212a of the mounting member 210 described above. Accordingly, driving member 220′ is configured to partially or completely overlie the bracket 212a of mounting member 210. A rear outer surface of the driving member 220′ defines a head 220b′ or other protrusion that is configured for engagement with a driving tool “D,” e.g., a powered drill or manual wrench or driver. Accordingly, head 220b′ may be configured as, e.g., a hex head. Head 220b′ is fixed on the driving member 220′, e.g., by brazing, welding, or being integrally formed with the driving member 220′. Accordingly, the rotation of head 220b′ causes rotation of the entire driving member 220′. Advantageously, driving tool “D” may also be used to insert the step 140 (FIG. 14) into tree “T,” as described above. It is contemplated that driving tool “D” may include magnetized portions, e.g., a drill bit, to aid in engaging and minimizing inadvertent loss of other metallic components, e.g., head 220b′ of driving member 220′ or step 140.

In use, driving member 220′ is placed to overlie the bracket 212a of mounting member 210 such that the bracket 212a of mounting member 210 is at least partially disposed in the recess 220a′. Driving tool “D” is engaged with the head 220b′ of the driving member 220′. Upon actuation of the driving tool “D”, the driving member 220′ rotates, and, being in close engagement with the bracket 212a, causes the bracket 212a to rotate and the shank portion 214 of mounting member 210 to threadably engage the tree “T.” Continued rotation of the driving member 220′ with the driving tool “D” results in the shank portion 214 being partially or completely disposed within the tree “T,” with the bracket 212a of the mounting member 210 exposed on an outer surface of the tree “T,” as described above.

Turning now to FIGS. 26 and 27, use of the tree stand 100 by the hunter “H” will be shown. With the tree stand 100 securely coupled to the tree “T,” the hunter “H” may then stand on the base 120 of the unfolded tree stand 100. Additionally, the seat 130 may be transitioned to the unfolded position such that the person “H” may sit atop the seating area defined in the seat 130, and sit atop tree stand 100. From this position, at a chosen vertical height along the tree “T,” the hunter “H” is afforded a substantially unobstructed view of the area surrounding the base of the tree “T” and beyond. Such a vantage point is desirable for a variety of outdoor activities, e.g., hunting, surveying, and photography.

Additional equipment or accessories, e.g., a hunting bow “B” may be supported on the engagement portion 128b of the accessory-holding extension arm apparatus 128 as shown. The engagement portion 128b of the accessory-holding extension arm apparatus 128 has a configuration, e.g., the S-shaped configuration described above, such that the hunting bow “B” is engaged to be maintained in a vertical orientation with respect to the base 120 of the tree stand 120. According, the hunting bow “B” is held at arms-reach from the hunter “H” such that the hunting bow “B” may be grasped and used by the hunter “H” at any chosen time.

Additionally, a utility arm 300 is shown which may be utilized in conjunction with tree stand 100. Utility arm 300 includes a retaining mechanism, for example, a spring loaded clamp or quick release mechanism to readily secure an item to the utility arm 300. For example, the hunter “H” may wish to secure a video recording device such as video camera 302 to film while the hunter “H” is free to move about without having to hold the video camera 302. Utility arm 300 may be mounted to the tree “T” by the same methods as detailed above for mounting member 210 or by other suitable means, e.g., a screw, nail, or tie. Utility arm 304 includes a number of foldable arms 304a, 304b, 304c configured to pivot relative to each other at joints 305. Camera 302 may be fixedly or pivotably mounted about an outermost arm 304a of the utility arm 300, or on a support mount 303, as shown. Joints 305, as shown, afford each arm 304a, 304b, 304c a degree of freedom to rotate about an axis defined by each joint 305. In some embodiments, arms 304a, 304b, 304c have multiple degrees of freedom, e.g., by connection with a ball joint. Utility arm 300 is configured for mounting to tree “T” at a location such that a vantage point similar to that of the hunter “H” is captured by the camera 302, e.g., over the shoulder of the hunter “H”. Arms 304a, 304b, 304c may be then be manipulated relative to each other to facilitate optimal positioning of the camera 302.

Turning now to FIGS. 28-30, uncoupling of the tree stand 100 from the tree “T” will be described. Upon completion of the desired activity atop the tree stand 100, the hunter “H” may step off the base 120 of the tree stand 100 onto another surface, such as a step 140 or other structure as described above. The hunter “H” may then grasp the base 120 and transition the tree stand 100 from the unfolded configuration to the folded configuration as shown. With the tree stand 100 still in the folded configuration, and coupled with the mounting member 210, the securing member 230 may be untied or unwrapped from the cleat 118. Thereafter, the portable platform may be lifted out of the mounting member 210, and the tree stand 100 may be lowered from the tree “T,” either by carrying the tree stand 100 down the vertical height of the tree “T,” or by remaining stationary and using the securing member 230 to lower the tree stand 100 to the ground.

In this manner, the tree stand 100 may be carried away from the tree “T” and re-used on a different structure. Accordingly, the tree stand 100 is configured for multiple uses, and only mounting member 210 remains coupled with the tree “T.” Such a configuration minimizes the visibility of the tree stand 100 over extended periods of time, as opposed to a permanently installed configuration. Such a design is desirable as it maintains the secrecy of a chosen vantage point, as well as prolonging the usable life of the tree stand 100 by minimizing exposure to damaging elements, e.g., outdoor weather or continual strain from being mounted on the tree

Turning to FIG. 31, a portable support apparatus system or kit 400 is provided. Each of the above-described components of the portable support system may be provided as a packaged kit to ensure that a hunter “H” is provided with all components of the portable support system prior to use. Specifically, the tree stand 100 or tree stand 100′, installation system 200 including the mounting member 210, the driving member 220, and the securing member 230, and a safety harness (not shown) may be included in a packaging, e.g., a bag, box, or carrying case. In some embodiments, at least one of the steps 140, utility arm 300, mounting member 210′, and driving member 220′ and/or associated driving tool “D” may be included in the packaging. It will be understood that some or all of the herein disclosed components may be included in the packaging in any desirable combination.

In one embodiment, kit 400 includes a carrying case 402 designed and adapted for housing tree stand 100 or 100′ and/or other components disclosed herein. Carrying case 402 further includes a masking scent. The masking scent can include materials that eliminate scent, cover scent, and/or attract selected wildlife. The masking scent can be impregnated into the fabric of carrying case 402, be in the form of pellets disposed within an interior space of carrying case 402, and/or be coated on an interior surface of carrying case 402. With tree stand 100 stored in carrying case 402, the masking scent can act on each component of tree stand 100 to eliminate and/or cover scents associated with the various components of tree stand 100.

Carrying case 402 is also configured to resist and/or prevent odors from infiltrating an interior of carrying case 402. It is contemplated that carrying case 402 may include taped zippers, taped seams, an air impermeable inner lining and/or any other suitable material or fabrication technique to resist and/or prevent penetration of odor-producing gases, such as, for example, motor vehicle gas emissions, into carrying case 402.

In an alternative embodiment, kit 400 can include a shipping pouch 404 designed and adapted for transporting tree stand 100 or tree stand 100′ and/or other components disclosed herein. Shipping pouch 404 includes a masking scent, similar to the masking scent described above. Shipping pouch 404 can encapsulate tree stand 100 to protect tree stand 100 from damage during transportation of tree stand 100 from a factory to a delivery location while also eliminating or masking any scents associated with tree stand 100 that may repel wildlife. It is further contemplated that shipping pouch can include packing material disposed therein that is coated and/or impregnated with scent masking substances.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

1. A method of mounting a portable platform, comprising:
securing a mounting member to a vertically oriented support structure;
inserting a coupling member of a portable platform into a cavity defined in the mounting member;
securing the portable platform to the vertically oriented support structure with a securing member disposed about an attachment surface extending from the portable platform; and
unfolding a base of the portable platform from a back portion of the portable platform such that a brace extending from a rearward portion of the base pressibly engages the vertically oriented support structure.

2. The method of claim 1, wherein securing the mounting member to a vertically oriented support structure includes threadably inserting a portion of the mounting member into the vertically oriented support structure.

3. The method of claim 1, wherein securing the mounting member to a vertically oriented support structure includes inserting a driving member through the cavity defined in the mounting member and rotating the driving member to cause rotation of the mounting member.

4. The method of claim 1, wherein securing the mounting member to a vertically oriented support structure includes inserting a driving member through an opening defined in the mounting member into engagement with a socket defined in the mounting member and rotating the driving member to cause rotation of the mounting member.

5. The method of claim 1, wherein securing the mounting member to a vertically oriented support structure includes rotating the driving member to cause rotation of the mounting member.

6. The method of claim 1, wherein securing the mounting member to a vertically oriented support structure includes overlying a driving member on a portion of the mounting member.

7. The method of claim 6, further including rotating a head defined on the driving member with a driving tool.

8. The method of claim 1, further including securing the mounting member to the vertically oriented support structure with a securing strap.

9. The method of claim 1, further including mounting a video recording device in relation to the portable platform.
